(19) United States
(12) Patent Application Publication
(10) Pub. No.: US 2008/0083005 A1
(43) Pub. Date: Apr. 3, 2008

(54) METHOD AND APPARATUS FOR PROCESSING DIGITAL MOBILE BROADCAST-RELATED DATA IN MOBILE COMMUNICATION TERMINAL USING UNIVERSAL SUBSCRIBER IDENTITY MODULE

(75) Inventor: Kang Wook Kim, Daegu Metropolian City (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/859,621

(22) Filed: Sep. 21, 2007

(30) Foreign Application Priority Data
Sep. 29, 2006 (KR) 2006-0096216

(51) Int. Cl. H04N 7/173

(52) U.S. Cl. 725/118

(57) ABSTRACT

A method and apparatus for processing digital mobile broadcast-related data are disclosed. The method and apparatus store digital mobile broadcast-related data, such as an Electronic Program Guide (EPG), a favorite channel list, etc., in a Universal Subscriber Identity Module (USIM), and update the stored data, such that the digital mobile broadcast-related data can be used by a mobile communication terminal, and even by a mobile communication terminal that has newly replaced another mobile communication terminal.

### PRIORITY

This application claims priority under 35 U.S.C. §119(a) to an application entitled “METHOD AND APPARATUS FOR PROCESSING DIGITAL MOBILE BROADCAST-RELATED DATA IN MOBILE COMMUNICATION TERMINAL USING UNIVERSAL SUBSCRIBER IDENTITY MODULE” filed in the Korean Intellectual Property Office on Sep. 29, 2006 and assigned Serial No. 2006-0096216, the contents of which are incorporated herein by reference.

### BACKGROUND OF THE INVENTION

1. Field of the Invention

The present invention relates to a mobile communication terminal with a Universal Subscriber Identity Module (USIM), which receives digital mobile broadcasts. More particularly, this invention relates to a method and apparatus that store digital mobile broadcast-related data, such as an Electronic Program Guide (EPG), a favorite channel list, etc., in a USIM, and update the stored data, such that the digital mobile broadcast-related data can be used by a mobile communication terminal, and even by a mobile communication terminal that has newly replaced another mobile communication terminal.

2. Description of the Related Art

Today, demands related to digital mobile broadcasting, such as Digital Multimedia Broadcasting (DMB), Digital Video Broadcasting (DVB), Media Forward Link Only (MediaFLO), etc., are remarkably increasing. Such digital mobile broadcasting is a new type of broadcast service, which is different from analog broadcasting. The digital mobile broadcasting technology is created as mobile communication technology and broadcasting are mixed. In recent years, the digital mobile broadcast can be received through a common mobile communication terminal, such as a portable terminal, other than a dedicated terminal for receiving digital mobile broadcasts.

The mobile communication terminal receives a variety of added data as well as broadcast programs in a digital mobile broadcast receive mode. The added data includes an Electronic Program Guide (EPG) or an Electronic Service Guide (ESG), which is referred to as electronic broadcast information. Also, the added data includes a variety of information, such as news, traffic, weather, living, stock, and home-shopping information, electronic commercial transaction information, etc. However, since the conventional mobile communication terminal has stored this data in its memory, if a user purchases a new mobile communication terminal, the user cannot use the data (electronic broadcast information) stored in the old mobile communication terminal.

Also, while viewing a digital mobile broadcast, the user often saves the channel in a favorite channel list. However, since the favorite channel list is also stored in the memory of the mobile communication terminal, if the user replaces the old mobile communication terminal, he/she cannot utilize this list.

Furthermore, the conventional mobile communication terminal may often install a Universal Subscriber Identity Module (USIM) therein. The USIM, also called a Subscriber Identity Module (SIM) or a Universal Identity Module (UIM), is in the shape of a card. The USIM is a type of Integrated Circuit (IC) chip that stores personal information to provide a variety of services, such as, subscriber authorization, global roaming, billing, security, etc. If the USIM is implemented with a type of card, the USIM can be freely coupled to and separated from one terminal to another terminal.

### SUMMARY OF THE INVENTION

The present invention is made to solve the above problems, and therefore, the present invention provides a method and apparatus that store digital mobile broadcast-related data, such as electronic broadcast information, a favorite channel list, etc., in a Universal Subscriber Identity Module (USIM) installed in a mobile communication terminal that can receive the digital mobile broadcast, such that the digital mobile broadcast-related data stored in the USIM can be used in a new mobile communication terminal.

The present invention further provides a method and apparatus that automatically update digital mobile broadcast-related data, such as electronic broadcast information, etc., stored in a USIM installed in a mobile communication terminal that can receive the digital mobile broadcast.

In accordance with an exemplary embodiment of the present invention, a method for processing digital mobile broadcast-related data of digital mobile broadcasting in a mobile communication terminal using a Universal Subscriber Identity Module (USIM) included receiving broadcast data of the digital mobile broadcasting; extracting the digital mobile broadcast-related data from the received broadcast data; and storing the extracted digital mobile broadcast-related data in the USIM.

Preferably, the method further includes determining whether the USIM is installed in the mobile communication terminal. If the USIM is determined to be installed in the mobile communication terminal, the storing is performed. The digital mobile broadcast-related data includes electronic broadcast information. If the digital mobile broadcast-related data has already been stored in the USIM, the storing further comprises updating the digital mobile broadcast-related data.

In accordance with another exemplary embodiment of the present invention, a method for processing digital mobile broadcast-related data of digital mobile broadcasting in a mobile communication terminal using a Universal Subscriber Identity Module (USIM) includes checking whether a setting menu for the digital mobile broadcast-related data is executed; checking whether specific digital mobile broadcast-related data is set through the setting menu; and storing the selected specific digital mobile broadcast-related data in the USIM.

Preferably, the method further includes determining whether the USIM is installed in the mobile communication terminal. If the USIM is determined to be installed in the mobile communication terminal, the storing is performed. The digital mobile broadcast-related data includes favorite channels.

In accordance with another exemplary embodiment of the present invention, a method for processing digital mobile broadcast-related data of digital mobile broadcasting in a mobile communication terminal using a Universal Subscriber Identity Module (USIM) includes if the mobile communication terminal has booted, checking whether the digital mobile broadcast-related data is stored in the USIM; extracting a data creation date and time from the digital mobile broadcast-related data stored in the USIM; determining whether a time has elapsed from the data creation date and time; receiving broadcast data of the digital mobile broadcasting; extracting the digital mobile broadcast-related data from the received broadcast data; and storing the extracted digital mobile broadcast-related data in the USIM to update the USIM.

Preferably, the method further includes determining whether the USIM is installed in the mobile communication terminal. If the USIM is determined to be installed in the mobile communication terminal, the checking is performed. The digital mobile broadcast-related data includes electronic broadcast information.

In accordance with another exemplary embodiment of the present invention, an apparatus for processing digital mobile broadcast-related data of digital mobile broadcasting in a mobile communication terminal using a Universal Subscriber Identity Module (USIM) includes a USIM detector for checking whether the USIM is installed in the mobile communication terminal; a broadcast receiver for receiving broadcast data of the digital mobile broadcasting; a data processing unit for extracting the digital mobile broadcast-related data from the received broadcast data; and a controller for storing the extracted digital mobile broadcast-related data in the USIM.

In accordance with another exemplary embodiment of the present invention, an apparatus for processing digital mobile broadcast-related data of digital mobile broadcasting in a mobile communication terminal using a Universal Subscriber Identity Module (USIM), includes a USIM detector for checking whether the USIM is installed in the mobile communication terminal; and a controller for checking whether a setting menu for the digital mobile broadcast-related data is executed, for checking whether specific digital mobile broadcast-related data is set through the setting menu, and for storing the selected specific digital mobile broadcast-related data in the USIM.

In accordance with another exemplary embodiment of the present invention, an apparatus for processing digital mobile broadcast-related data of digital mobile broadcasting in a mobile communication terminal using a Universal Subscriber Identity Module (USIM) includes a USIM detector for checking whether the digital mobile broadcast-related data is stored in the USIM; a broadcast receiver for receiving broadcast data of the digital mobile broadcasting; a data processing unit for extracting a data creation date and time from the digital mobile broadcast-related data stored in the USIM, and the digital mobile broadcast-related data from the received broadcast data; and a controller for checking whether the digital mobile broadcast-related data is stored in the USIM if the mobile communication terminal has booted, for determining whether a time has elapsed from the data creation date and time, and for storing the extracted digital mobile broadcast-related data in the USIM to update it.

### BRIEF DESCRIPTION OF THE DRAWINGS

The objects, features, and advantages of the present invention will be more apparent from the following detailed description in conjunction with the accompanying drawings, in which:

FIG. 1 is a view illustrating that a USIM card is exchangeable between mobile communication terminals;

FIG. 2 is a schematic block diagram illustrating a mobile communication terminal according to an embodiment of the present invention;

FIG. 3 is a flow chart illustrating a method for processing digital mobile broadcast-related data according to an embodiment of the present invention;

FIG. 4 is a view depicting a display screen where electronic broadcast information of the digital mobile broadcast-related data is displayed;

FIG. 5 is a flow chart illustrating a method for processing digital mobile broadcast-related data according to another embodiment of the present invention; and

FIG. 6 is a flow chart illustrating a method for processing digital mobile broadcast-related data according to still another embodiment of the present invention.

### DETAILED DESCRIPTION OF EXEMPLARY EMBODIMENTS

Hereinafter, exemplary embodiments of the present invention are described in detail with reference to the accompanying drawings. The same reference numbers are used throughout the drawings to refer to the same or like parts. Detailed descriptions of well-known functions and structures incorporated herein may be omitted to avoid obscuring the subject matter of the present invention.

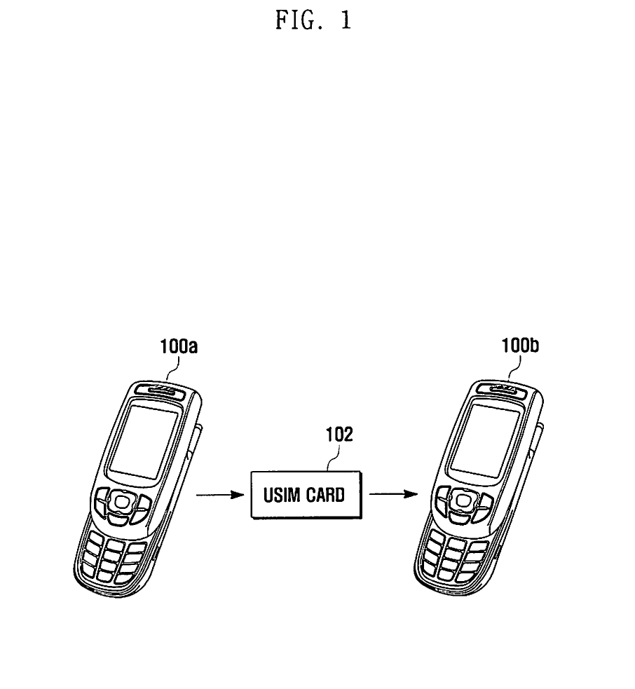

FIG. 1 is a view illustrating that a USIM is exchangeable between mobile communication terminals.

Referring to FIG. 1, the USIM 102 can be installed to and removed from the mobile communication terminals 100a and 100b according to the present invention. The USIM 102 stores personal information to provide services, such as subscriber authorization, etc., and digital mobile broadcast-related data, such as electronic broadcast information, a favorite channel list, etc. If the USIM 102 is implemented with a USIM card, the USIM card 102 is installed to a mobile communication terminal 100a for use and then removed from the mobile communication terminal 100a to be reinstalled to another mobile communication terminal 100b. In this case, the data previously used in the mobile communication terminal 100a can be used in the mobile communication terminal 100b.

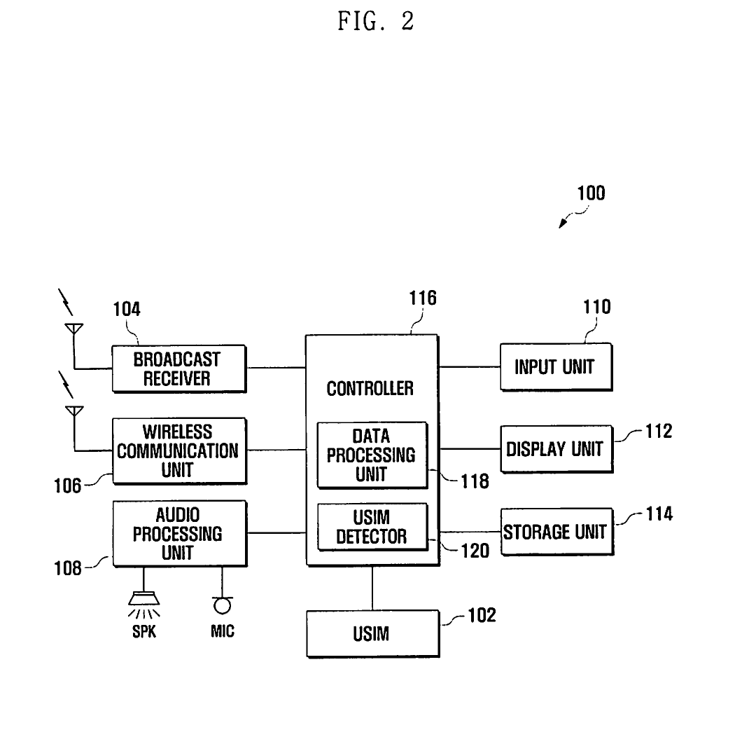

FIG. 2 is a schematic block diagram illustrating a mobile communication terminal according to an embodiment of the present invention.

As shown in FIG. 2, the mobile communication terminal 100 has a USIM 102 and receives digital mobile broadcasts. The mobile communication terminal 100 includes a broadcast receiver 104, a wireless communication unit 106, an audio processing unit 108, an input unit 110, a display unit 112, a storage unit 114, and a controller 116. The controller 116 includes a data processing unit 118 and a USIM detector 120. The mobile communication terminal 100 may further include a plurality of elements that provide added functions, such as a camera function, a music playback function, a short-range wireless communication function, etc., according to various user demands.

The USIM 102 is preferably implemented by a card, and installed into the mobile communication terminal 100. The USIM 102 stores digital mobile broadcast-related data, such as electronic broadcast information, a favorite channel list, etc. The electronic broadcast information, which is also referred to as an Electronic Program Guide (EPG) or an Electronic Service Guide (ESG), includes broadcast programs, broadcast channels, start and end times of broadcast programs, etc., which are provided by broadcasting stations. The favorite channel list includes broadcast channels set by a viewer. The digital mobile broadcast-related data includes news, weather, traffic, stock information, and home-shopping information, electronic commercial transactions, etc.

The broadcast receiver 104 serves to receive digital mobile broadcasts. The digital mobile broadcasting can provide services based on DMB, DVB, or media-FLO. The broadcast receiver 104 includes a tuner that tunes to a frequency of a physical channel to selectively receive broadcast signals there through and a demodulator that demodulates the broadcast signals received through the physical channel to a Transport Stream (TS). The broadcast receiver 104 outputs the demodulated transport stream to the controller 116, where the transport stream is a Motion Picture Experts Group 2 Transport Stream (MPEG2 TS).

The wireless communication unit 106 serves to transmit and receive voice signals and messages to and from other wireless communication units, respectively, thereby allowing their terminals to communicate. The wireless communication unit 106 includes an RF transmitter for up-converting the frequency of transmitted signals and amplifying the transmitted signals and an RF receiver for low-noise amplifying received RF signals and down-converting the frequency of the received RF signals i.e., the wireless communication unit 106 converts a modulation signal from the controller 116 to an Intermediate Frequency (IF) signal and then converts the IF signal to an RF signal. Next, the RF signal is transmitted to a base station through an antenna. Also, the wireless communication unit 106 receives an RF signal from the base station through the antenna and then converts the RF signal to an IF signal and a baseband signal, in that order, to transmit the signals to the controller 116.

The audio processing unit 108 plays an audio signal output from the controller 116 back or transmits an audio signal, such as a voice signal, inputted though a microphone to the controller 116 i.e., the audio processing unit 108 converts an analog voice signal received through the microphone into a digital signal called Pulse Code Modulation (PCM), and transmits the digital signal to the controller 116. Further, the audio processing unit 108 converts a digital signal of a caller's voice from the controller 116 into an audible analog signal to output it to the speaker.

The input unit 110 outputs an input signal generated by a user to the controller 116. For example, when a user executes a favorite channel setting menu and selects a specific favorite channel, the input unit 110 detects the user's input and generates a corresponding input signal. The input unit 110 may be implemented with a pointing device, such as a touch pad, as well as with a common keypad.

The display unit 112 displays a variety of information on its screen according to the control of the controller 116. For example, the display unit 112 displays a broadcast program that the broadcast receiver 104 receives according to a user's channel selection, electronic broadcast information, or a favorite channel setting menu. The display unit 112 is generally implemented with a Liquid Crystal Display (LCD) but may be implemented with other display devices. If the display unit 112 is implemented with a touch screen, the display unit 112 can also serve to perform a part of or all of input functions, instead of the input unit 110.

The storage unit 114 stores a variety of programs and data that are executed or processed under the control of the controller 116. For example, the storage unit 114 stores an Operating System (OS) for booting the mobile communication terminal 100, and application programs for a variety of functions of the terminal 100. Also, the storage unit 114 stores data for the application programs and data generated during the execution of the application programs.

The controller 116 controls the entire operation of the mobile communication terminal 100. Specifically, the controller 116 controls the signal flows between the broadcast receiver 104, the wireless communication unit 106, the audio processing unit 108, the input unit 110, the display unit 112, and the storage unit 114. The data processing unit 118 of the controller 116 extracts electronic broadcast information from the broadcast data received through the broadcast receiver 104 or extracts creation dates and times from the electronic broadcast information. The USIM detector 120 of the controller 116 detects whether the USIM 102 is installed into the mobile communication terminal 100.

The following is a description of a method for processing digital mobile broadcast-related data, according to the present invention. Although the following will describe an embodiment of the present invention in a case where the digital mobile broadcast-related data is an EPG, it should be understood that other digital mobile broadcast-related data could be applied in like manner.

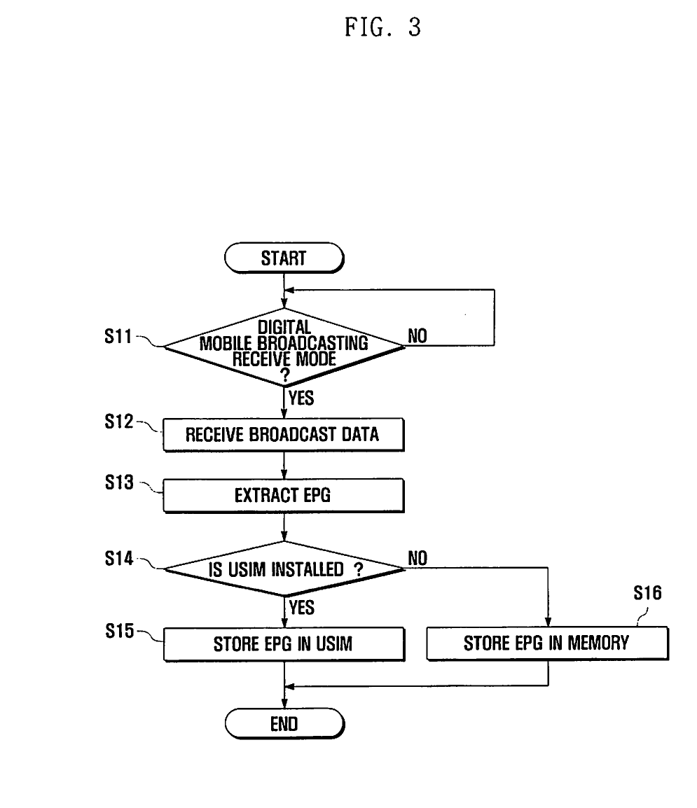

FIG. 3 is a flow chart illustrating a method for processing digital mobile broadcast-related data according to an embodiment of the present invention.

Referring to FIGS. 2 and 3, the controller 116 determines whether the mobile communication terminal 100 is currently in a digital broadcast reception mode, in step S11. If the current mode is in a digital broadcast reception mode, the broadcast receiver 104 receives broadcast data and transmits it to the controller 116, in step S12. The data processing unit 118 of the controller 116 extracts an EPG from the received broadcast data, in step S13.

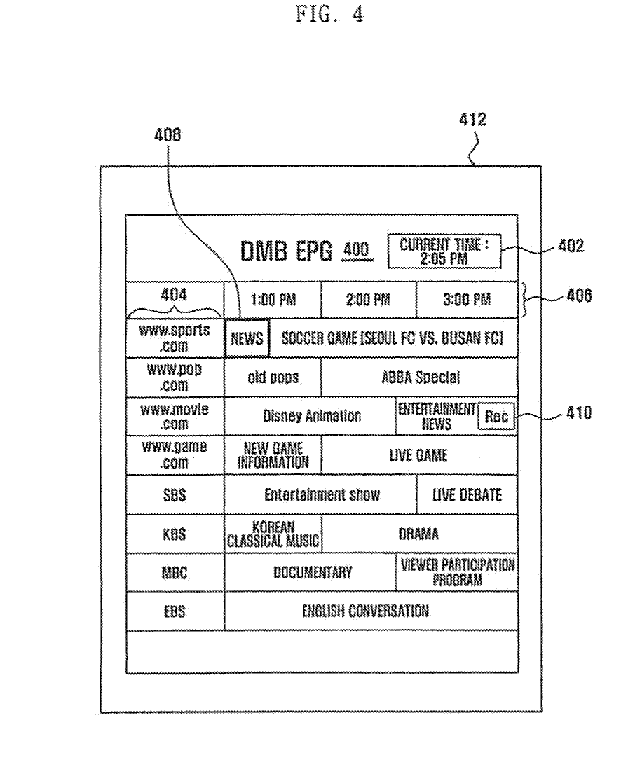

An example of the extracted EPG is shown in FIG. 4. The EPG 400 used for DMB is displayed on the display screen 412. The display screen 412 displays the current time 402 at the upper right, and broadcast channels 404 and broadcast times 406, which are aligned along the left vertical axis and the upper horizontal axis, respectively. Each broadcast channel (for example, www.sports.com) is composed of broadcast programs whose names (for example, news 408) are displayed according to the broadcast times. If a certain broadcast program is selected through a key input or a touch, a record button “Rec” 410 appears at the side of a corresponding broadcast program name. If the record button 410 is enabled, it can record a current broadcast program or a reserved broadcast program when the reserved recording time arrives.

Returning to FIGS. 2 and 3, the USIM detector 120 of the controller 116 determines whether the USIM 102 is installed to the mobile communication terminal 100, in step S14. If the USIM 102 is installed, the controller 116 stores the EPG extracted by the data processing unit 118 in the USIM 102, in step S15. However, if the USIM 102 is not installed, the controller 116 stores the EPG in the storage unit 114, in step S16.

As described above, the present invention can store the digital mobile broadcast-related data, such as an EPG, in the USIM or the storage unit, depending on whether the USIM is installed to the mobile communication terminal. If the digital mobile broadcast-related data is stored in the USIM, it can be used in another mobile communication terminal because the USIM storing the digital mobile broadcast-related data can be shifted from one mobile communication terminal to another. Further, concerning the digital mobile broadcast-related data, a user's setting data, such as a favorite channel list, can be stored in the USIM, which will be described below.

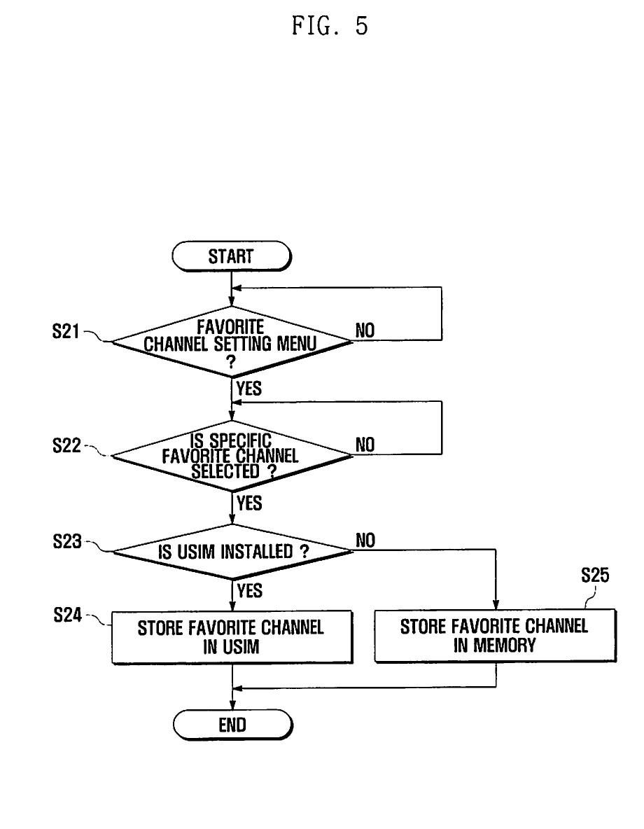

FIG. 5 is a flow chart illustrating a method for processing digital mobile broadcast-related data according to another embodiment of the present invention.

Referring to FIGS. 2 and 5, the controller 116 determines whether a favorite channel setting menu is executed in step S21. The favorite channel setting menu is stored in the storage unit 114 and executed when a user inputs selections through the input unit 110. Preferably, the favorite channel setting menu may be set in a digital mobile broadcast receive mode, but may be set in another mode as well.

Next, the controller 116 determines whether a certain favorite channel is selected from the favorite channel setting menu, in step S22. Here, selecting a favorite channel means that one or more of broadcast channels is selected or a storage command is inputted. The channel selection and storage command input are performed using different input keys of the input unit.

Next, the USIM detector 120 of the controller 116 determines whether the USIM 102 is installed to the mobile communication terminal 100, in step S23. If the USIM 102 is installed, the controller 116 stores the favorite channel list in the USIM 102, in step S24. On the contrary, if the USIM 102 is not installed, the controller 116 stores the favorite channel list in the storage unit 114, in step S25.

As described above, the present invention can store the digital mobile broadcast-related data, such as a favorite channel list, in the USIM or the storage unit, depending on whether the USIM is installed to the mobile communication terminal. If the digital mobile broadcast-related data is stored in the USIM, the digital mobile broadcast-related data can be used in another mobile communication terminal because the USIM storing the digital mobile broadcast-related data can be shifted from one mobile communication terminal to another.

Although the two embodiments described above are implemented in such a way that the digital mobile broadcast-related data is stored in the USIM or the storage unit depending on whether the USIM is installed to the mobile communication terminal, it should be understood that the present invention should not be restricted by the embodiments. For example, there may be a modification where the digital mobile broadcast-related data may be stored in both the USIM and the storage unit without a determination as to whether the USIM is installed.

The following is a description of a method for updating the digital mobile broadcast-related data stored in the USIM. Although the following will describe an embodiment of the present invention in the case that the digital mobile broadcast-related data is an EPG, it should be understood that other digital mobile broadcast-related data could be applied in the same manner.

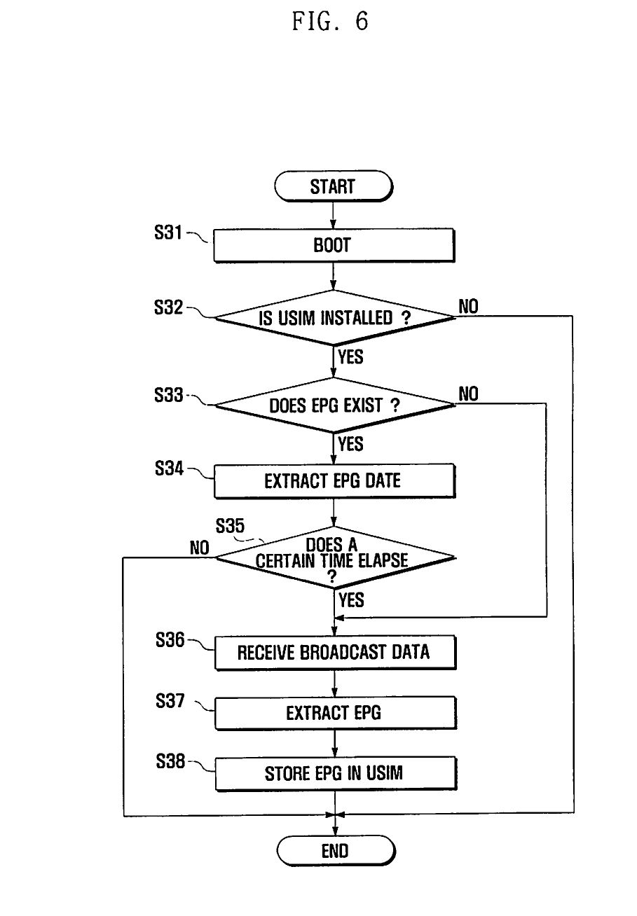

FIG. 6 is a flow chart illustrating a method for processing digital mobile broadcast-related data according to still another embodiment of the present invention.

Referring to FIGS. 2 and 6, when the mobile communication terminal 100 has booted, in step S31, the USIM detector 120 of the controller 116 determines whether the USIM is installed into the terminal 100, in step S32. If the USIM 102 is installed, the controller 116 checks whether an EPG is stored in the USIM 102, in step S33. If the EPG is stored, the data processing unit 118 of the controller 116 extracts an EPG creation date and time from the EPG, in step S34.

The controller 116 compares the extracted EPG creation date and time with the current date and time and determines whether the extracted EPG creation date and time, in step S35, has arrived. If the extracted EPG creation date and time has arrived, the controller 116 controls the broadcast receiver 104 to receive broadcast data, in step S36.

Next, the data processing unit 118 extracts an EPG from the received broadcast data, in step S37. The extracted EPG is stored in the USIM 102 under the control of the controller 116, in step S38. In this stage, since the USIM 102 has already stored an EPG (which is called an existing EPG), the existing EPG is updated by the newly input EPG.

On the contrary, if the predetermined time has not elapsed the EPG creation date and time at step S35, the EPG update procedures, steps 36 to 38, are skipped. Also, if the EPG is not stored in the USIM 102 at step S33, the procedure proceeds with step S36 to store an EPG in the USIM 102.

Although the present invention has been described based on the EPG updating method where an EPG is updated when the mobile communication terminal has booted, it should be understood that the EPG updating method should not restrict the method for updating digital mobile broadcast-related data. For example, the embodiment of the present invention can be implemented in such a way that the digital mobile broadcast-related data can be updated when digital mobile broadcast is first received after the terminal has booted. The modification can be implemented using the data processing method, referring to FIG. 3. Therefore, such modification will not be described in this application.

Also, the EPG updating method of FIG. 6 need not necessarily display received broadcast data on the display unit, i.e., even when the mobile communication terminal is not in a digital mobile broadcast receive mode, the EPG updating method receives broadcast data, extracts an EPG from the received broadcast data, and updates an existing EPG in the USIM.

Although exemplary embodiments of the present invention have been described in detail hereinabove, it should be understood that many variations and modifications of the basic inventive concept herein described, which may be apparent to those skilled in the art, will still fall within the sprit and scope of the exemplary embodiments of the present invention as defined in the appended claims.

What is claimed is:

1. A method for processing digital mobile broadcast-related data of digital mobile broadcasting in a mobile communication terminal using a Universal Subscriber Identity Module (USIM), comprising:
receiving broadcast data of the digital mobile broadcasting;
extracting the digital mobile broadcast-related data from the received broadcast data; and
storing the extracted digital mobile broadcast-related data in the USIM.

2. The method of claim 1, further comprising:
determining whether the USIM is installed in the mobile communication terminal,
wherein, if the USIM is determined to be installed in the mobile communication terminal, the storing is performed.

3. The method of claim 1, wherein the digital mobile broadcast-related data comprises electronic broadcast information.

4. The method of claim 1, wherein, if the digital mobile broadcast-related data has already been stored in the USIM, the storing further comprises updating the digital mobile broadcast-related data.

5. A method for processing digital mobile broadcast-related data of digital mobile broadcasting in a mobile communication terminal using a Universal Subscriber Identity Module (USIM), comprising:
determining whether a setting menu for the digital mobile broadcast-related data is executed;
determining whether specific digital mobile broadcast-related data is set through the setting menu; and
storing the selected specific digital mobile broadcast-related data in the USIM.

6. The method of claim 5, further comprising:
determining whether the USIM is installed in the mobile communication terminal,
wherein, if the USIM is determined to be installed in the mobile communication terminal, the storing is performed.

7. The method of claim 5, wherein the digital mobile broadcast-related data comprises favorite channels.

8. A method for processing digital mobile broadcast-related data of digital mobile broadcasting in a mobile communication terminal using a Universal Subscriber Identity Module (USIM), comprising:
if the mobile communication terminal has booted, determining whether the digital mobile broadcast-related data is stored in the USIM;
extracting a data creation date and time from the digital mobile broadcast-related data stored in the USIM;
determining whether a time has elapsed from the data creation date and time;
receiving broadcast data of the digital mobile broadcasting;
extracting the digital mobile broadcast-related data from the received broadcast data; and
storing the extracted digital mobile broadcast-related data in the USIM to update the USIM.

9. The method of claim 8, further comprising:
determining whether the USIM is installed in the mobile communication terminal,
wherein, if the USIM is determined to be installed in the mobile communication terminal, the storing is performed.

10. The method of claim 8, wherein the digital mobile broadcast-related data comprises electronic broadcast information.

11. An apparatus for processing digital mobile broadcast-related data of digital mobile broadcasting in a mobile communication terminal using a Universal Subscriber Identity Module (USIM), comprising:
a USIM detector for determining whether the USIM is installed in the mobile communication terminal;
a broadcast receiver for receiving broadcast data of the digital mobile broadcasting;
a data processing unit for extracting the digital mobile broadcast-related data from the received broadcast data; and
a controller for storing the extracted digital mobile broadcast-related data in the USIM.

12. The apparatus of claim 11, wherein the digital mobile broadcast-related data comprises electronic broadcast information.

13. The apparatus of claim 11, wherein
the controller determines whether a setting menu for the digital mobile broadcast-related data is executed, checks whether specific digital mobile broadcast-related data is set through the setting menu, and stores the set specific digital mobile broadcast-related data in the USIM.

14. The apparatus of claim 13, wherein the digital mobile broadcast-related data comprises favorite channels.

15. An apparatus for processing digital mobile broadcast-related data of digital mobile broadcasting in a mobile communication terminal using a Universal Subscriber Identity Module (USIM), comprising:
a USIM detector for determining whether the digital mobile broadcast-related data is stored in the USIM;
a broadcast receiver for receiving broadcast data of the digital mobile broadcasting;
a data processing unit for extracting a data creation date and time from the digital mobile broadcast-related data stored in the USIM and extracting the digital mobile broadcast-related data from the received broadcast data; and
a controller for, if the mobile communication terminal has booted, checking whether the digital mobile broadcast-related data is stored in the USIM, for determining whether a time has elapsed from the data creation date and time, and for storing the extracted digital mobile broadcast-related data in the USIM to update it.

16. The apparatus of claim 15, wherein the digital mobile broadcast-related data comprises electronic broadcast information.
